(19) United States
(12) Patent Application Publication
(10) Pub. No.: US 2006/0237970 A1
(43) Pub. Date: Oct. 26, 2006

(54) Perpetual motion comptrollers & energy molecule splitters

(76) Inventor: Rudolph Bailey SR., Manassas Park, VA (US)

Correspondence Address: RUDOLPH BAILEY SR., P.O. Box 221911, Chantilly, VA, 20153, US

(21) Appl. No.: 11/331,474

(22) Filed: Jan. 5, 2006

Related U.S. Application Data
(63) Continuation-in-part of application No. 10/811,382, filed on Mar. 27, 2004, now abandoned.
(60) Provisional application No. 60/644,725, filed on Jan. 18, 2005.

(51) Int. Cl. H02K 7/18; F03G 7/08; F02B 63/04

(52) U.S. Cl. 290/1 R

(57) ABSTRACT

A method to convert a battery operated device into a perpetual motion machines has been disclosed. A method for splitting an energy molecule in two and making two molecule from the one while recycling the energy has disclosed. The increased energy is used to offset that which will be loss due to friction, and to do useful work. A molecule splitter and comptroller is used to control the refurbishing of said batteries one at a time, and to rest the drive motor, so as to prevent the device from coming to a stop. Since the method used does not create new energy, but generate new energy by splitting the energy molecule, it does not violate the laws of energy conversion, or the laws of thermodynamics.

### DESCRIPTION OF RELATED APPLICATIONS

This Application is a continuation-in-part of co-pending application Ser. No. 10/811,382 filled on Mar. 27, 2004. This application also claims the benifit of PPA Ser. No. 60/644,725, filed on Jan. 18, 2005.

### BACKGROUND

This version of the invention Is concerned with the field of control devices used to control perpetual motion machines, and energy molecule splitters that can be used to increase the energy within a system. More specifically, this version of the invention is concerned with prior art control devices and technology using timing controls, and computer hardware and software including alpha-digital or voice-sound commands or instructions, for a new and unintended, and unforeseen use, to produce perpetual motion which is believed to be both scientifically and practically impossible.

### PRIOR ART

An example of said control devices can be seen as is exemplified in U.S. Pat. No. 5,804,948 System for Zero Emission Generation of Electricity, issued to Frost on Sep. 8, 1998. Frost shows a comptroller 501 which switches back and forth between two 12-volt batteries 101 & 102 and an alternator 401. The purpose intended is to keep a generator 301 in operation for an indefinite period, without need for a separate recharging of said batteries.

### DISCUSSION OF THE PRIOR ART

As illustrated by background art, efforts are continuously being made in an attempt to develop control devices to facilitate perpetual motion machines. Frost's invention falls short of its intended goal, as the device is inoperable, and violates the second law of thermodynamics, and the laws of energy conversion. The device also makes improper use of component parts, hence the said comptroller would be of no value in facilitating perpetual motion of Frost's device.

The reasons are as following, Frost is using a 12-volt deep cycle bay to operate a 12-volt-1/4HP motor, to operate a 12-volt alternator, to convert 12-volts into the 15-volts it would take to charge a 12-volt battery. The said action will violate the laws of energy conversion. In addition to that their would be friction and heat resulting in the loss of some of the energy from the 12-volt battery, so Frost's invention also violates the second law of thermodynamics. In addition to that Frost would also be using an automobile type alternator to recharge two discharged batteries, said alternators are not designed to charge a discharged battery, such charging must be accomplished by using a AC to DC trickle type battery charger. Another problem with Frost's invention is that a ¼-HP motor is not sufficient to operate a 12-volt Alternator when it is in a charging cycle, plus a 9,500watt generator. In addition to all that is mentioned, the said alternator would burn out prematurely as it would be in a charge cycle continuously as it charges one battery for four hours, and then the next battery for four hours, back and forth with no rest period. Additionally when said alternator is in a charging mode the resistance tends to slow down the drive motor, if no rest periods are introduced said drive motor will eventually come to a stop. I do not understand why a patent was granted on Frost's invention. As I mentioned earlier this patent application only covers the comptrollers and energy molecule splitters used in perpetual motion machines, and not the perpetual motion machine itself, that is covered in co-pending application Ser. No. 10/811,382, filed on Mar. 27, 2004.

As illustrated by background art, efforts are continuously being made in an attempt to develop control devices in order to make perpetual motion machines become possible. No prior effort, however, provides a means attendant with the present invention. As such, it may be appreciated that there is a continuing need for the development of control devices to help make the benefits of perpetual motion machines available to human kind. As such the present invention incorporates prior art technology for a new use, that was unforeseen and unintended, which when modified to provide control devices that can facilitate perpetual motion machines. Additionally the prior patent and use of component parts do not suggest the present inventive combination of component elements arraigned and configured as disclosed herein.

The present invention achieves its intended purposes, objects, and advantages through a new, useful and unobvious combination of methods steps and component elements, with the use of a minimum number of functioning parts, at a reasonable cost to manufacture, and by employing only readily available materials.

### SUMMARY

The present version of the invention, which will be described in greater detail hereinafter, relates to the field of control devices and energy molecule splitters that are used to help to make perpetual motion machines possible, including computer hardware and software and programs. More specifically, this version of the invention is concerned with a timing and switching and control component we call an energy molecule splitter, which incorporates prior art technology for a new unintended, and unforeseen use, to help make perpetual motion machines possible.

In order to be able to described the present invention briefly, according to a typical embodiment. We must first explain what we at JESUS & Bailey call the “Science of Perpetual Motion Machine”. In order to develop perpetual motion and do useful work, one must first be able to recycle the energy within a system or device, resulting in no waste or emissions. Next one must be able to split each energy molecule and take one molecule, and make two as one recycle said energy. In so doing one will be able to generate enough new energy within the system, to overcome what will be lost due to friction and heat, and also to do useful work. Said new science is possible in a DC battery operated system.

Let us consider a 24-volt-DC circuit comprising two 12volt deep cycle batteries connected to give 24-volts. Additionally let us consider a 24-volt-DC motor being operated by said batteries. The motor will convert the electrical energy from the battery into turning motion. Said turning motion with the use of mechanical advantage could be used to set in motion a charging component such as an alternator, and the intended work load. Said charging component could transform said turning motion back to electrical energy. Said electrical energy could be used to refurbish said batteries, which would keep said drive motor in operation indefinitely. This action will take care of the recycling step. However some of the energy from the battery will be lost due to friction and heat loss. If we use a 24-volt alternator as the charging component, we would have to generate 29-30volts to refurbish the said 24-volt batteries. One can easily see why that will not happen. Said example would violate the laws of energy conversion and the second law of thermodynamics. To eliminate the obvious need for outside energy to keep the system in operation, we have devised a way to increase the energy within the system without any energy from an outside source, by splitting the energy molecule, and making two from one.

Here is how this is accomplished. Suppose you had one telephone line coming into your home, and you needed another phone in another room, what would you do? Run another line? no, you would use a two-way signal splitter and you would have two full phones, not two hall phones although you split the signal in two. Let us apply that analogy to this problem. Instead of using one 24-volt alternator, suppose two 12-volt alternators were used instead, then we would be splitting the energy molecules in two. Now we cannot use both alternators at the same time or we will have the same original problem. If we use one at a time we will begin to solve the problem, since we would be using a 24-volt by to convert to the 14.5-15-volts we would need to charge one 12-volt battery at a time. You would now have two full alternators each one capable of refurbishing the batteries. If you add up the volts from both alternators you get 30-volts. This would be 25% more than we need to operate the system, hens we have enough energy to refurbish the batteries, replace that which will be loss due to friction and do useful work. Said example does not violate the laws of energy conversion. It does not violate the laws of thermodynamics, since we are not creating new energy within the system, instead we are generating additional energy by splitting the energy molecules. Consider a wife and husband having a child, they do not say we created a new child, but the child is referred to as part of their generations, from the same root word. In like manner the additional energy is not created but generated. The word create means to make something from nothing, and we are not doing that. When you split anything and make two things from the one you automatically have an increase. This is what the Lord Jesus did in the creation of the universe, after He made man he put him to sleep and split him open and took a rib out, and closed him up, and with the rib, He made woman, and when the man and woman got together in the fullness of time, they continue to generate new life perpetually as long as this world will last. When you follow a divine principle it always works.

Now we need a energy splitter & controller to control the charging process one battery at a time. This is the purpose of this patent application, and not to patent a perpetual motion machine, that is done in co-pending application Ser. No. 10/811,382 filed on Mar. 27, 2004. The Molecule spiller is a timing and switching comptroller that is comprised of a master control board, and an insulated hot pointer, a modulating motor with cams and collar, and three output terminals and one feed terminal. The comptroller is set to send 24-volts to each alternator's solenoids for one minute intervals, with two ½ minute rest periods per cycle for the drive motor, for a total charge cycle time of three minutes. This means that the alternations must operate at a rate, three times above the rate of the drive motor. This faster rate also allows the alternator to generate more amps than the system takes to operate it. Hens from calculations we can generate about 25 to 35% more amps than needed to operate the system, thus we can refurbish the batteries, overcome friction and to do useful work.

Our invention, therefore, resides not in any one of these features per se, but rather in the particular combination of all of them herein disclosed. It is distinguished from the prior art in this particular combination of all of its structures for the functions specified.

In order that the detailed description of the invention may be better understood, and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description, or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Accordingly, it is an object of our version of the invention to provide a low-cost, easy-to-manufacture, and easy-to-market perpetual motion comptroller & energy molecule splitter, for helping to make perpetual motion machines possible.

A further object of our version of the invention is to provide an easy to install and easy to use perpetual motion comptroller & molecule splitter, for perpetual motion machines.

A significant object of the invention is to provide a light weight and easy to service and easy to replace perpetual motion comptroller & energy molecule splitter.

A final but significant object of the invention is to provide a trouble free fool-proof control device that will not cause damage to the system it is installed in if it malfunctions, but is safe and reliable.

For a better understanding of the invention, its operating advantages and the specific objects attained by its uses, reference should be made to the accompanying drawings and descriptive matter, in which there is illustrated a preferred embodiment of the invention. These objects should be construed to be merely illustrate of some of the more prominent features and applications of the present invention. Many other beneficial results can be attained by applying the disclosed invention in a different manner, or by modifying the invention within the scope of the disclosure. Accordingly, other objects and a fuller understanding of the invention may be had by referring to the summary of the invention, and the detailed description of the preferred embodiment, in addition to the scope of the invention illustrated by the accompanying drawings.

### BRIEF DESCRIPTION OF THE DRAWINGS

The foregoing and other objects, features and advantages of the invention will become more fully understood from the following description of The preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is a perspective view showing a perpetual motion comptroller and molecule splitter in conjunction with other related parts as it would be installed and wired.

FIG. 1A is a plan view of a perpetual motion comptroller and molecule splitter with top cover removed showing the internals.

FIG. 1B is a perspective arrangement of an alternate embodiment showing a tachometer added which is used to control the charging operation.

### DRAWING REFERENCE NUMERALS

25 Perpetual Motion Comptroller & Energy Molecule Splitter with Internal 9-volt Battery
32 Positive and Negative Wires to 24-volt Circuit
34 24-volt Tachometer with High and low set point for turning Power on and off
36 Positive 24-volt Signal Wire from Tachometer
38 12-volt Tachometer Sensing Wire
70 Main Control Board
71 Positive “A” Solenoid Terminal
72 Negative “A” Solenoid Terminal
73 Positive Feed Terminal
74 Negative Feed Terminal
75 Positive “C” Solenoid Terminal
76 Negative “C” Solenoid Terminal
78 Modulating Motor
80 Cam Collar
82 Insulated Hot Pointer
85 & 85 Positive & negative to 24-volt Drive Motor (not shown)
86 Exciter Wire to Alternator (2)
87 Exciter Wire to Alternator (1)

93 On/Off Switch
96 Negative Wire to Alternator (A1)
97 Positive Wire to Alternator (A1)
98 Negative Wire to Alternator (A2)
99 Positive Wire to Alternator (A2)
114 Remote Communicator/Controller
115 Central Processing Unit
117 External Speaker
122 Touch Monitor
500C Solenoid to Battery (B1) Positive
500 Solenoid to Battery (B1) Negative
508A Solenoid to Battery (B2) Positive
508 Solenoid to Battery (B2) Negative

### DESCRIPTION OF THE PREFERRED EMBODIMENT

Description

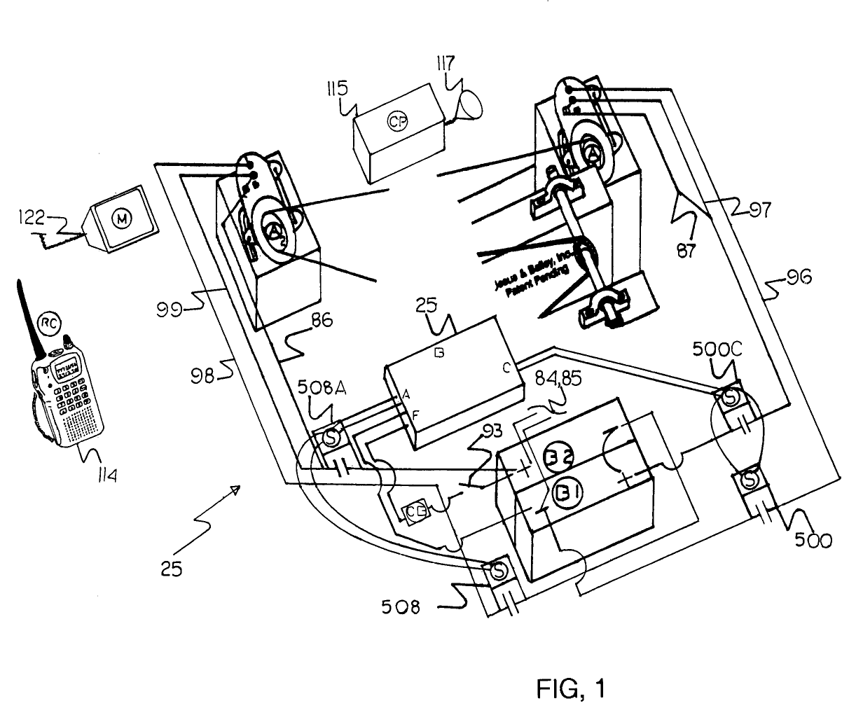

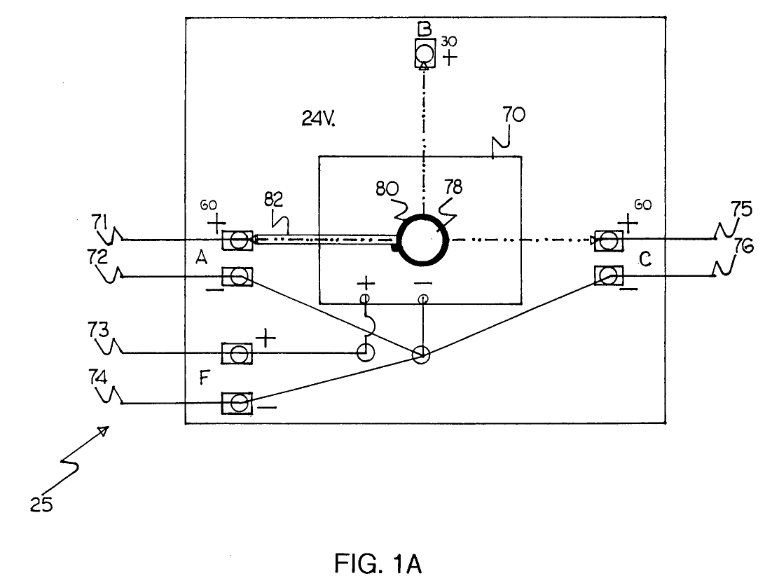

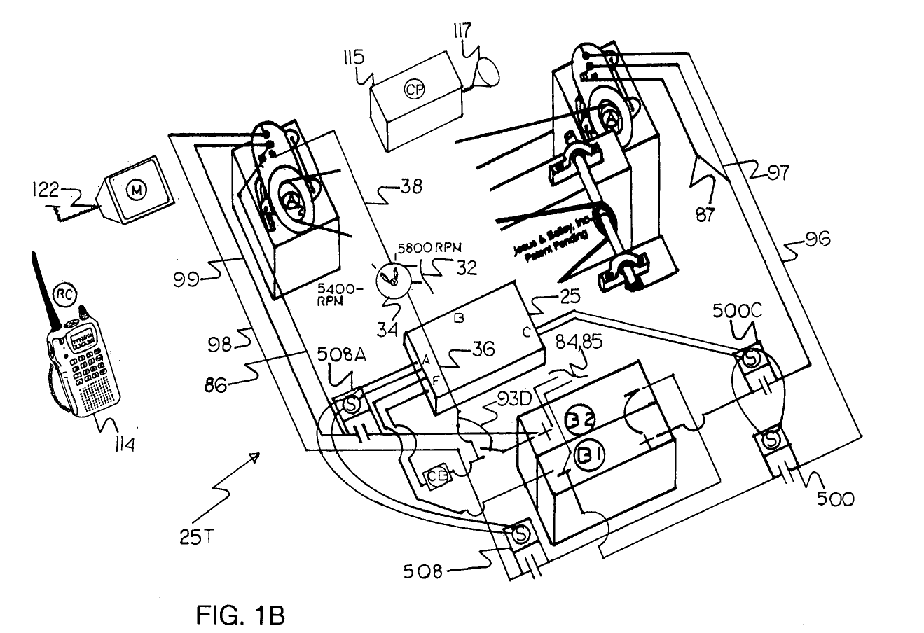

Referring now to the drawings and, in particular, to FIG. 1 wherein there is illustrated a typical embodiment of a perpetual motion comptroller & energy molecule splitter 25. The present version of the invention 25 which casing is constructed non-conductive materials such as plastic or fiber glass, with a removable cover. FIG. 1 shows how comptroller 25 inter-relates with its associate component parts which are covered in co-pending application Ser. No. 10/811,382, and are not part of this application.

Referring to now to FIG. 1A, wherein is illustrated the internals of comptroller 25, with a main control board 70, which controls the timing and switching of the 24-volt power supply to the external alternator solenoids. Pointer 82, is insulated and moves the 24-volts to the output terminals A, B, & C. Terminal F, is 24-volt feed intake to main control board 70.

Referring again to FIG. 1, when switch 93 is closed 24-volts goes to Comptroller 25, via wires 73 & 74, (FIG. 1A). Pointer 82 which is normally at the A terminal when power supply is in the off position, sends 24-volts via wires 71 & 72 to alternator Solenoids 508A & 508 for 60 seconds. Said action will cause alternator A2 to refurbish battery B2, for a 1-minute interval. Next hot pointer 82, (FIG. 1A) travels to the B, terminal and pauses for 30 seconds, this will allow drive motor to rest for a ½ minute before hot pointer 82 moves to the C, terminal, and pauses for 60 seconds, sending 24-volts to alternator solenoids 500C & 500, via wires 75 & 76. Said action will allow alternator A1 to charge battery B1, for 1 minute. Next hot pointer 82 will travel back to the B, terminal and pause for 30 seconds, giving drive motor another ½ rest before it moves back to the A terminal for 60 seconds, to repeat the continuous charging cycle, back and forth, as long as switch 93 remain in the on position. Said action will facilitate perpetual motion, by increasing energy within the system enough to offset what is lost due to friction, and allow useful work to be done. When switch 93 is turned off, hot pointer 82 will automatically return to the A terminal. An optional no charging light can be connected to the B terminal.

Various methods can be employed to accomplish the refurbishing process of batteries B1 & B2, as explained above, and comptroller 25 can be made to operate in different ways. The methods explained does not limit this application to one format, or technology in accomplishing the above task. Said comptroller can work together with a computer like central processor 115 with speaker 117, or said process could be performed with the use of sophisticated computerized controls which can perform other duties such as turning device on and off, and warnings of possible problems or malfunctions, or displaying values and readings on touch monitor 122, or on remote communicator/controller 114, which also functions as a mobile phone and two-way radio. Such duties can involve digital, or sounds or voice and verbal commands and instructions. The use of any computer hardware, software, or program or such like use of any and all prior art technology is considered as part of this application as a new unforeseen and unintended use, to facilitate perpetual motion machines. Furthermore the timing chosen is only for example, and any timing cycle that is proven to work may be used. The present invention is also patentable as an improvement over the sighted prior art, for the reasons sighted in the discussion of the prior art, and the summary of the invention. Prose applicant request that such patent as explained be granted.

### DESCRIPTION OF THE ALTERNATE EMBODIMENT

Description

Referring now to the drawings and in particular to FIG. 1B wherein there is illustrated an alternate embodiment of a perpetual motion comptroller and energy molecule splitter 25T. The present version of the invention 25T consist of all components as version 25, with the inclusion of a tachometer switch 34, and a double throw normally open, normally close contact switch 93D in place of switch 93. Tach-switch 34 operates on 24-volts, with a 12-volt sensing wire to alternator, and has two set points. One set point is at 5800-PRM for a 24-volt system and 3100-RPM for a 12-Volt system. The other set point is at 5400-RPM for a 24-volt system and 2700 RPM for a 12-volt system (the example illustrated is a 24-volt system). When alternators attain 5800-RPM Tachometer Switch 34 sends 24-volts to Comptroller 25. Comptroller 25 will operate as usual, sending 24-volts to alternator solenoids allowing one alternator to commence the charging of the related battery until alternator drops to 5400-RPM. At that point tachometer switch 34 turn the power off to comptroller 25 thereby stopping the said charging process. Comptroller 25 pointer will always move to the B rest position when no power is on. When alternator attains 5800-RPM once more, comptroller pointer will send power to the other alternator solenoids thereby causing said alternator to charge the related battery. When alternator drops to 5400-RPM tach-switch 34 will turn power off to Comptroller 25, thereby stopping the charging process, and pointer will again return to the B rest position and wait for alternators to reach 5800-RPM once more. At that point the charging of the other battery will take place as previously explained. This process will continue back and forth, as long as the system is in operation. Said process will allow the system to stay in operation indefinitely. Changing the position of switch 93D will cause comptroller 25 to operate on a timing cycle as was explained in the preferred embodiment of the invention. A second tachometer without a switch could be installed on the other alternator to monitor belt slippage, should both tachometer not have the same reading in revolutions per minute.

### CONCLUSION AND SCOPE OF INVENTION

From the foregoing, it will be understood by persons skilled in the art that an improved method to make the benefits of perpetual motion machines available to humans has been provided. The invention is relatively simple and easy to manufacture, yet affords a variety of uses. While our description contains many specifications, these should not be construed as limitations on the scope of the version of the invention, but rather as an exemplification of the preferred embodiment thereof. The foregoing is considered as illustrative only of the principles of the invention. Further, since numerous modifications and changes will readily occur to those skilled in the art, it is not desired to limit the invention to the exact construction and operation shown and described. Accordingly all suitable modifications and equivalents may be resorted to, falling within the scope of the invention. Although this invention has been described in its preferred form with a certain degree of particularity, it is understood that the present disclosure of the preferred form has been made only by way of example. Accordingly numerous changes in details of construction and combination and arrangement of parts may be resorted to, without departing from the spirit and scope of the invention.

1. What I claim is a method to split energy molecules in a battery operated circuit as said energy is receded in order to increase energy enough to offset lost to friction and do useful work whereby facilitating perpetual motion and a method to control the refurbishing of said batteries one at a time and to rest the system equally using prior art technology such as computer hardware software programs and timing and switching controls and a remote communicator/controller which also acts as mobile phone and two-way radio as a new use to facilitate perpetual motion.
